(19) United States
(12) Patent Application Publication
(10) Pub. No.: US 2007/0099045 A1
(43) Pub. Date: May 3, 2007

(54) FUEL CELL DEVICE CAPABLE OF ADJUSTING OPERATIONAL PARAMETERS

(76) Inventors: Feng-Yi Deng, Taipei (TW); Yu-Lin Tang, Taipei (TW); Ya-Chien Chung, Taipei (TW)

Correspondence Address: G. LINK CO., LTD., 3550 BELL ROAD, MINOOKA, IL, 60447, US

(21) Appl. No.: 11/553,809

(22) Filed: Oct. 27, 2006

(30) Foreign Application Priority Data
Oct. 28, 2005 (TW) 094218632

(51) Int. Cl. H01M 8/04; H01M 8/24

(52) U.S. Cl. 429/22; 429/38; 429/24

(57) ABSTRACT

A fuel cell device capable of adjusting operational parameters is disclosed, which includes fuel cell boards, an anode regulator, a cathode regulator, an anodic fuel supplier, and a control circuit. The fuel cell boards include an electrically connected interface to communicate status signals generated by the fuel cell boards during operation. The anode regulator is connected to the anodic fuel inlets and the anodic fuel outlets of the fuel cell boards and provides anodic fuels with predetermined parameters. The cathode regulator adjusts an amount of cathodic fuels supplied for cathodes of the fuel cell boards. The anodic fuel supplier is connected to the anode regulator and contains anodic fuels. The control circuit receives the status signals from the fuel cell boards, controls the anodic fuel supplier and the anode regulator based on the status signals to make the concentration, flow rate and temperature of anodic fuels injected into the fuel cell boards meet predetermined parameters, and controls the cathodic fuel supplier based on the status signals to make the flow rate of cathodic fuels injected into the fuel cell board meet predetermined parameters.

### FIELD OF THE INVENTION

The present invention relates to a fuel cell device, and more particularly, to a fuel cell device capable of adjusting operational parameters, which sets the operational conditions on the fuel cell device, monitors the operational records, and controls the performance of the fuel cell device.

### BACKGROUND OF THE INVENTION

The assigned United States Patent Application Publication Number US2005/0158608A1, entitled “Method For Manufacturing a Layer Lamination Integrated Fuel Cell And The Fuel Cell Itself” discloses how to fabricate a fuel cell board by printed circuit board processes.

The conventional fuel cell has a cell core that performs electrochemical reactions and outputs power The performance of the cell core, such as output voltage/current, fuel temperature, fuel concentration, etc., is conducted by the cell core that performs electrochemical reactions with predetermined and unchangeable parameters. Presently, there is no efficient, reliable test system to follow the relationship between the performance of the fuel cell and the operational parameters thereof. Additionally, a test system is demanded to connect the performance and the operational parameters during the electrochemical reactions in the fuel cell, so as to control the performance of the fuel cell and to satisfy the experimental requirements for the developers of fuel cells.

Since it is essential to simulate and control the operations of a fuel cell, a fuel cell capable of adjusting operational parameters is needed.

### SUMMARY OF THE INVENTION

It is a first object of the invention to provide a fuel cell device capable of adjusting operational parameters, to overcome the aforesaid disadvantages in the related prior art.

It is a second object of the invention to provide a fuel cell device capable of adjusting operational parameters, which sets the operational parameters of the fuel cell boards, tests and records the operational status of the fuel cell boards, and retrieves the information about the performance associated with the operational parameters of the fuel cell boards.

It is a third object of the invention to provide a fuel cell device capable of adjusting operational parameters. The fuel cell device uses the information about the operational status associated with the operational parameters to control its performance, and thereby the experimental requirements for the developers of fuel cells are met.

In accordance with the aforesaid objects of the invention, a fuel cell device capable of adjusting operational parameters is provided, which includes fuel cell boards, an anode regulator, a cathode regulator, an anodic fuel supplier, and a control circuit. The fuel cell boards include an electrically connected interface to communicate status signals generated by the fuel cell boards in operation. The anode regulator is connected to the anodic fuel inlets and the anodic fuel outlets of the fuel cell boards and provides anodic fuels with predetermined parameters. The cathode regulator adjusts an amount of cathodic fuels supplied for cathodes of the fuel cell boards. The anodic fuel supplier is connected to the anode regulator and contains anodic fuels. The control circuit receives the status signals from the fuel cell boards, controls the anodic fuel supplier and the anode regulator based on the status signals to make the concentration, flow rate and temperature of anodic fuels injected into the fuel cell boards meet predetermined parameters, and controls the cathodic fuel supplier based on the status signals to make the flow rate of cathodic fuels injected into the fuel cell boards meet predetermined parameters.

### BRIEF DESCRIPTION OF THE DRAWINGS

These and other modifications and advantages will become even more apparent from the following detained description of a preferred embodiment of the invention and from the drawings in which:

FIG. 1 illustrates the structure of a fuel cell device able to regulate operational parameters according to one embodiment of the invention; and

FIG. 2 shows the cross section of a gas-liquid separator in accordance with one embodiment of the invention.

### DETAILED DESCRIPTION OF THE INVENTION

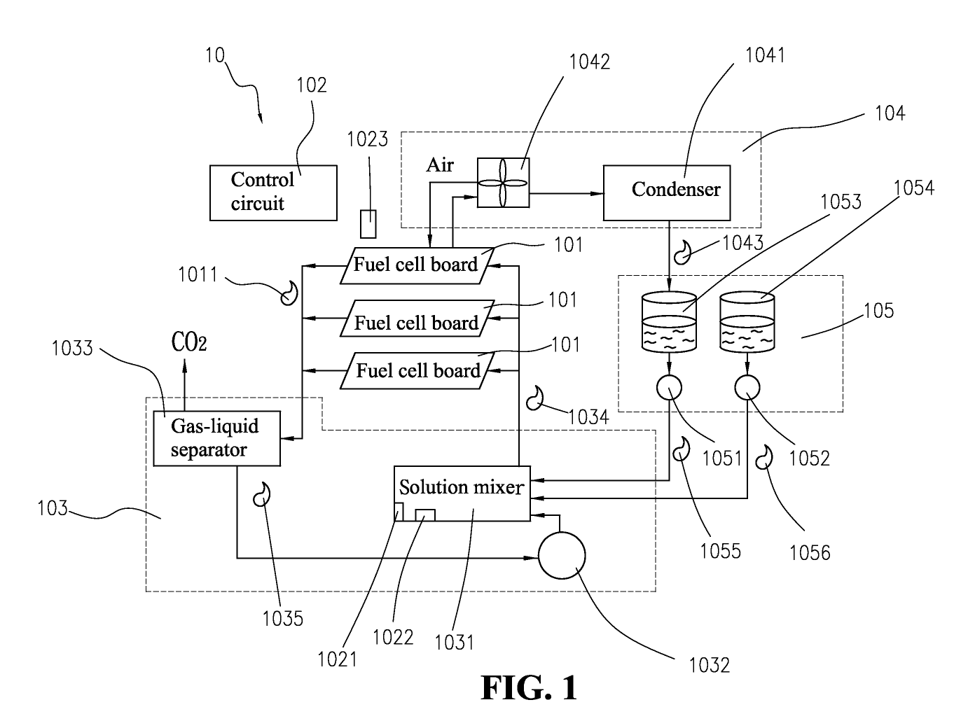

FIG. 1 illustrates the structure of a fuel cell device able to adjust operational parameters according to one embodiment of the invention. The fuel cell device 10 capable of adjusting operational parameters utilizes one or more fuel cell boards 101 as power generators, controls over other related devices using a control circuit 102 to set or regulate the operational parameters of the fuel cell boards 101, and constantly monitors the performance of all the fuel cell boards 101 in use.

The fuel cell device 10 capable of adjusting operational parameters includes at least one fuel cell board 101, a control circuit 102, an anode regulator 103, a cathode regulator 104, and an anodic fuel supplier 105, which are separately described hereinafter. For clarifying the invention, a direct methanol fuel cell (DMFC) is illustrated in this embodiment; however, the structure disclosed in the invention may be applied to any other fuel cells with liquid anodic fuels.

The control circuit 102 includes a calculating controller (not shown). The control circuit 102 retrieves the information about the current temperature and current concentration of methanol solution 1034 through a first temperature sensor 1021 and a concentration meter 1022 disposed in a solution mixer 1031. In addition, the control circuit 102 controls and manages a first pump 1032, a second pump 1051 and a third pump 1052 to regulate the flow rate of fluids in and out of the pumps 1032, 1051 and 1052.

The control circuit 102 further includes a communication interface (not shown) providing a means of coupling itself to an external electronic device (i.e. computer) for data exchange. The communication interface may be a USB communication interface, for example. The control circuit 102 also includes a voltage-regulated circuit (not shown) for regulating the output voltage from the fuel cell boards 101 to be constant. An exemplar of the control circuit 102 includes a printed circuit substrate with electronic components soldered thereon.

The anodic fuel supplier 105 includes, a water tank 1053, an anodic fuel tank 1054, a second pump 1051, and a third pump 1052. The water tank 1053 is a vessel for containing water. The source of water may be fresh water from the outside or recycled water 1043 from a condenser 1041. The anodic fuel tank 1054 is a container for storing a methanol solution with high concentration, such as pure methanol. The second pump 1051 is provided to expel water 1055 in the water tank 1053 and to control the flow rate of water 1055. The third pump 1052 is provided to propel a concentrated methanol solution 1056 within the anodic fuel tank 1054 and to control the flow rate of the concentrated methanol solution 1056.

The pumps 1051 and 1052 may be replaced by check valves.

The anode regulator 103 includes a solution mixer 1031, a first pump 1032 and a gas-liquid separator 1033. The solution mixer 1031 is in the form of a vessel having outlets (not shown) respectively connected to the inlets (not shown) of the fuel cell boards 101. The methanol solution 1034 inside the solution mixer 1031 is controlled by the control circuit 102 to have some predetermined parameters, such as predetermined concentration, temperature and flow rates. Only the methanol solution 1034 with predetermined parameters can be injected into the fuel cell boards 101.

The first pump 1032 is positioned between the solution mixer 1031 and the gas-liquid separator 1033. The first pump 1032 forces the methanol solution 1034 to pass through the fuel cell boards 101, and recycles the anodic products/recycled aqueous solution of methanol 1011 to flow into the gas-liquid separator 1033. Also, the first pump 1032 is provided to drive the recycled aqueous solution of methanol 1035 to the solution mixer 1031.

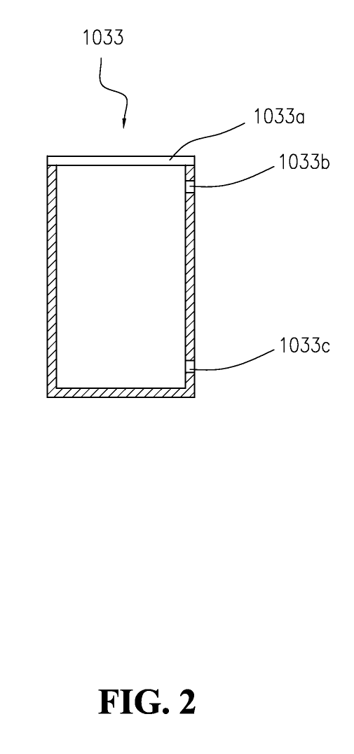

FIG. 2 shows the cross section of a gas-liquid separator in accordance with one embodiment of the invention. The gas-liquid separator 1033 is a container, and a gas permeable but liquid impermeable membrane 1033a covers the opening of the container tightly. Each anodic fuel outlet (not shown) of the fuel cell board 101 is connected to the inlet 1033b. The anodic products/recycled aqueous solution of methanol 1011 from the fuel cell boards 101 flow into the gas-liquid separator 1033 through the inlet 1033b. Then, the gas permeable but liquid impermeable membrane 1033a separates the recycled aqueous solution of methanol 1035 from the anodic products (e.g. carbon dioxide) contained in the anodic products/recycled aqueous solution of methanol 1011. The recycled aqueous solution of methanol 1035 inside the gas-liquid separator 1033 is pushed by the first pump 1032 such that the recycled aqueous solution of methanol 1035 flows towards the solution mixer 1031 through the outlet 1033c.

The cathode regulator 104 includes a condenser 1041 and a fan 1042. The fan 1042 causes external air to flow, and then provides air for the cathodes of the fuel cell boards 101. The condenser 1041 is placed near the fan 1042 to collect steam out of the fuel cell boards 101 and to condense the steam as recycled water 1043.

Furthermore, the fan 1042 is controlled by the control circuit 102. As such, the airflow of external air induced by the fan 1042 is controllable. The flowing air not only supplies oxygen, but also radiates heat from the fuel cell boards 101 in operation. A second temperature sensor 1023 disposed around the fuel cell boards 101 is used to detect the environmental temperature. Thereby, the control circuit 102 may provide an adequate environmental temperature that favors the proceeding of electrochemical reactions in the fuel cell boards 101.

The invention possesses one feature that the prior art lacks. That is, the fuel cell capable of regulating operational parameters can set various operational parameters so that the fuel cell board thereof generates power with the set parameters. In addition, the performance of the fuel cell board is controlled constantly, and every related operational parameter is adjusted dynamically.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel cell device capable of adjusting operational parameters, the fuel cell device comprising:
one or more fuel cell boards comprising an electrically connected interface for communicating at least one status signal generated by the fuel cell boards in operation;
an anode regulator connected to a plurality of anodic fuel inlets and a plurality of anodic fuel outlets of the fuel cell boards, wherein the anode regulator comprises:
a gas-liquid separator in a form of a vessel to recycle and store a fluid out of the anodic fuel outlets of the fuel cell boards;
a solution mixer in a form of a vessel connected to the anodic fuel inlets of the fuel cell boards, wherein the solution mixer contains a fluid from the gas-liquid separator, a water tank and an anodic fuel tank; and
a first pump for propelling fluids passing through the fuel cell boards, the gas-liquid separator and the solution mixer to cycle, and regulating the flow rate of fluids;
a cathode regulator to adjust an amount of cathodic fuels supplied for cathodes of the fuel cell boards, wherein the cathode regulator comprises:
a fan for propelling air and controlling a flow rate and air flowing in the cathodes of the fuel cell boards, wherein the air comes from outside,
an anodic fuel supplier connected to the anode regulator, wherein the anodic fuel supplier comprises:
the water tank being a container;
the anodic fuel tank being a container;
a second pump positioned between the water tank and the solution mixer to adjust an amount of water flowing from the water tank to the solution mixer; and
a third pump positioned between the anodic fuel tank and the solution mixer to adjust an amount of a concentrated anodic fuel flowing from the anodic fuel tank to the solution mixer; and
a control circuit for receiving the status signal from the fuel cell boards, controlling over the anodic fuel supplier and the anode regulator based on the status signal to make a concentration, a flow rate and a temperature of an anodic fuel injected into the fuel cell boards meet predetermined parameters, and controls a cathodic fuel supplier based on the status signal to make the flow rate of injected cathodic fuel into the fuel cell boards meet a predetermined parameter.

2. The fuel cell device of claim 1, wherein the first, second and third pumps, and the fan are electrically coupled to the control circuit and controlled by the control circuit.

3. The fuel cell device of claim 1, wherein the control circuit comprises:
a first temperature sensor to sense a temperature of a fluid within the solution mixer,
a concentration meter to detect a concentration of a fluid within the solution mixer; and
a controller to instruct the first, second and third pumps according to the status signals, a sensed signal from the first temperature and a detected signal from the concentration meter.

4. The fuel cell device of claim 1, wherein the cathode regulator further comprises a condenser for collecting steam out of the fuel cell boards and condensing the steam as water.

5. The fuel cell device of claim 4, wherein the condenser is disposed adjacent to the fan.

6. The fuel cell device of claim 4, wherein the condenser is connected to the water tank, and condensed water in the condenser is recycled to the water tank.

7. The fuel cell device of claim 1, wherein the fan radiates heat from the fuel cell boards.

8. The fuel cell device of claim 1, wherein the control circuit further comprises a second temperature sensor for sensing an environmental temperature around the fuel cell boards.

9. The fuel cell device of claim 1, wherein the control circuit is disposed on a printed circuit substrate.

10. The fuel cell device of claim 1, wherein the control circuit further comprises a communication interface coupled to an external electronic device for exchanging data with each other.

11. The fuel cell device of claim 1, wherein the gas-liquid separator further comprises a gas permeable but liquid impermeable membrane to separate a gaseous product from a liquid within the gas-liquid separator, and thereby the gaseous product escapes from the gas-liquid separator through the gas permeable but liquid impermeable membrane.

12. The fuel cell device of claim 1, wherein the fan is used to help the concentration to collect the steam.

13. The fuel cell device of claim 1, wherein the control circuit further comprises a voltage-regulated circuit for regulating a voltage output by the fuel cell boards to be constant.

14. The fuel cell device of claim 1, wherein the second pump is replaced by a check valve.

15. The fuel cell device of claim 1, wherein the third pump is replaced by a check valve.
